(19) United States
(12) Patent Application Publication
(10) Pub. No.: US 2008/0109483 A1
(43) Pub. Date: May 8, 2008

(54) MASH-UP SERVICE SYSTEM

(75) Inventors: Myung-won YOO, Yongin-si (KR); Joong-bok LEE, Seoul (KR)

Correspondence Address: CANTOR COLBURN, LLP, 20 Church Street, 22nd Floor, Hartford, CT, 06103, US

(73) Assignee: NEOMTEL CO., LTD., Seoul (KR)

(21) Appl. No.: 11/877,740

(22) Filed: Oct. 24, 2007

(30) Foreign Application Priority Data
Oct. 24, 2006 (KR) 10-2006-0103520

(51) Int. Cl. G06F 7/00; G06F 15/16; G06F 17/30

(52) U.S. Cl. 707/104.1; 709/203; 707/E17.001

(57) ABSTRACT

Provided is a mash-up service system including: a data processing module installed in a communication terminal which makes wired/wireless Internet communications, and transmitting multimedia data created by a user of the communication terminal and basic information provided by the communication terminal; and a mash-up server receiving the multimedia data and the basic information from the data processing module, tagging the multimedia data with the basic information to create first mash-up content, and transmitting the first mash-up content to a mash-up service apparatus.

### CROSS REFERENCE TO RELATED APPLICATIONS

This application claims priority from Korean Patent Application No. 10-2006-0103520, filed on Oct. 24, 2006, the disclosure of which is incorporated herein in its entirety by reference.

### BACKGROUND OF THE INVENTION

1. Field of the Invention

The present invention relates to a mash-up service system.

2. Description of the Related Art

A mash-up service means a technology of combining two or more resources to create a new resource on the web. For example, a mash-up service of combining Naver's news service with Daum's map service can be considered. In the mash-up service, by marking a location where news happens, a user can easily recognize where the corresponding accident occurs. Also, a convenient mash-up service of gathering and showing all news about a region selected on a map can be developed. An advantage of such mash-up services is that new resources can be easily created since the mash-up services use or combine existing open resources.

Recently, with the growth of electric and electronic technologies, various digital apparatuses, such as a digital camera interfaced with a computer, a camera phone, and a device equipped with an MP3 (MPEG-1 Audio Layer-3) player, a PMP (Portable Multimedia Player), and a camera, are widely being used. As Blogs, Personal Websites, etc. are supported by Internet web servers, more and more users desire to have their own content that is different from others' content and to share the content with others.

### SUMMARY OF THE INVENTION

The present invention provides a method of conventionally creating and distributing mash-up content with a communication terminal.

The present invention further provides a mash-up service system which can create and distribute mash-up content with abundant data by adding various kinds of content to multimedia data created by a communication terminal's user.

The present invention further provides a mash-up service system which can provide an interactive communication service between a communication terminal's user, which creates multimedia data and uploads the multimedia data to a mash-up server, and a content user, which uses content through the mash-up server.

According to an aspect of the present invention, there is provided a mash-up service system including: a data processing module installed in a communication terminal which makes wired/wireless Internet communications, and transmitting multimedia data created by a user of the communication terminal and basic information provided by the communication terminal; and a mash-up server receiving the multimedia data and the basic information from the data processing module, tagging the multimedia data with the basic information to create first mash-up content, and transmitting the first mash-up content to a mash-up service apparatus.

The communication terminal may have an additional function of receiving/transmitting images, animation, audio, etc., as well as a function of receiving/transmitting voice calls, text, etc. The basic information provided by the communication terminal includes at least one among terminal identification information, a current time, and terminal location information. The mash-up service apparatus means a terminal which can perform data communications with internet web servers, and may be an electronic device having a CPU, a memory, and an Internet interface, such as a personal computer, a notebook computer, a PDA, a cellular phone, any future Internet appliance.

According to the aspect of the present invention, the communication terminal's user can create and distribute mash-up content through the mash-up server by simple manipulation of creating at least one multimedia data among text, images, animation, and audio and inputting a transmission command, using an additional function of the communication terminal.

According to another aspect of the present invention, the mash-up server further includes a content adding processor receiving the multimedia data and the basic information from the data processing module, transmitting a content request message including the basic information to a content providing server connected to the mash-up server through a network, and receiving content related to the basic information from the content providing server, and a mash-up content generator generating mash-up data on the basis of the multimedia data transmitted from the data processing module and the content received from the content adding processor, and tagging the mash-up data with the basic information, thereby generating second mash-up content.

Here, the content providing server includes at least one among a map providing server, a weather providing server, a coupon providing server, an event providing server, and an advertisement providing server. According to the aspect of the present invention, the mash-up server can create and distribute mash-up content with abundant data.

According to another aspect of the present invention, the mash-up service system further includes a mash-up service apparatus receiving the mash-up content from the mash-up server, displaying the mash-up content on a screen, and transmitting a user response message for the mash-up content displayed on the screen to the mash-up server, and the mash-up server receives the user response message from the mash-up service apparatus, adds the user response message to the mash-up content to create third mash-up content, and transmits the third mash-up content to the mash-up service apparatus.

Here, the user response message includes at least one among text, an image, animation, and audio. According to the aspect of the present invention, the mash-up server provides an interactive communication service between a communication terminal's user which uploads multimedia data to the mash-up server and a user of the mash-up service apparatus.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a mash-up service system according to an embodiment of is the present invention;

FIG. 2 is a block diagram of a data processing module and a mash-up server, according to an embodiment of the present invention;

FIG. 3 is a block diagram of a mash-up service apparatus according to an embodiment of the present invention;

FIG. 4 is a flowchart of a mash-up service according to an embodiment of the present invention;

FIG. 5 is a flowchart of a mash-up service according to another embodiment of the present invention; and

FIG. 6 is a flowchart of a mash-up service according to still another embodiment of the present invention;

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

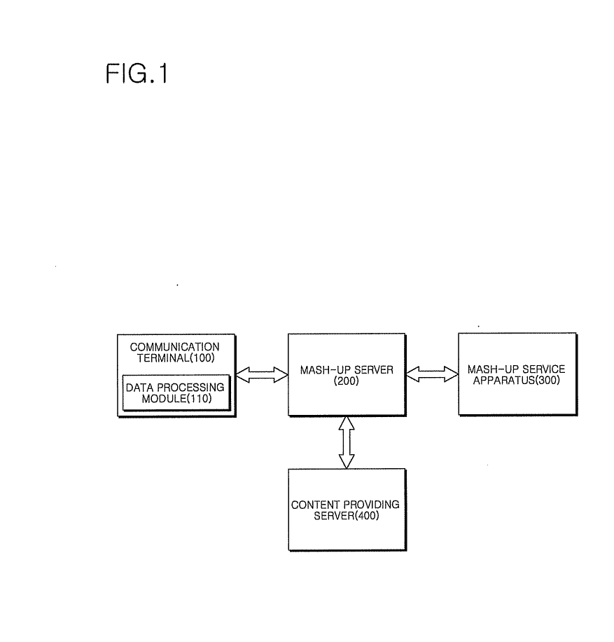

FIG. 1 is a schematic configuration diagram of a mash-up service system according to an embodiment of the present invention.

Referring to FIG. 1, the mash-up service system includes a communication terminal 100, a mash-up server 200, a mash-up service apparatus 300, and a content providing server 400.

The communication terminal 100 includes: a communication unit including a wireless communication unit or LAN card for extracting voice and data signals from a wireless signal which is transmitted or received through an antenna, and a wired communication device such as a network adapter; a voice processor for receiving or outputting voice signals; a manipulation unit for a user to input commands and data; a display unit for displaying a menu and an operation state; a memory for storing main programs and temporary data; and a controller, which are not illustrated in FIG. 1. In the current embodiment, the communication terminal 100 may be a cellular phone, a personal computer, a notebook computer, a PDA, each having an additional function of receiving/transmitting images, animation, audio, etc., as well as a function of receiving/transmitting voice calls, text, etc. The communication terminal 100 includes a data processing module 110 which is an application program for transmitting multimedia data created by a user of the communication terminal 100 and basic information (for example, terminal identification information, a current time, terminal location information) provided by the communication terminal 100, to the mash-up server 200. Preferably, the data processing module 110 can exchange data with a main program of the communication terminal 100. The operation of the data processing module 110 will be described in detail.

If the mash-up server 200, which is operatively connected to a wired/wireless Internet network, receives the multimedia data and basic information from the data processing module 110, the mash-up server 200 tags the multimedia data with the basic information, creates mash-up content, and transmits the mash-up content to the mash-up service apparatus 300.

The mash-up service apparatus 300 includes a CPU, a memory, an input device (for example, a keypad, a touch panel, a voice identifying device, or a keyboard), and an output device (for example, a LAN card for communications with a display, or a modem). Also, the mash-up service apparatus 300 can include an operating system on which a graphic user interface can be supported, and a pointing apparatus (for example, an apparatus on which a mouse is supported). The mash-up service apparatus 300 can access the mash-up server 200 and automatically download the mash-up content from the mach-up server 200.

The content providing server 400 is a web server which is established by existing content providers, and can include at least one among, for example, a map providing server, a weather providing server, a coupon providing server, an event providing server, and an advertisement providing server. Here, the event includes an art exhibition, a performance, an accident, etc. The mash-up server 200 is connected to the content providing server 400, processes content provided by the content providing server 400 and the multimedia data transmitted from the content providing server 400 to create mash-up data with a new format, tags the mash-up data with the basic information to create mash-up content, and transmits the mash-up content to the mash-up service apparatus 300.

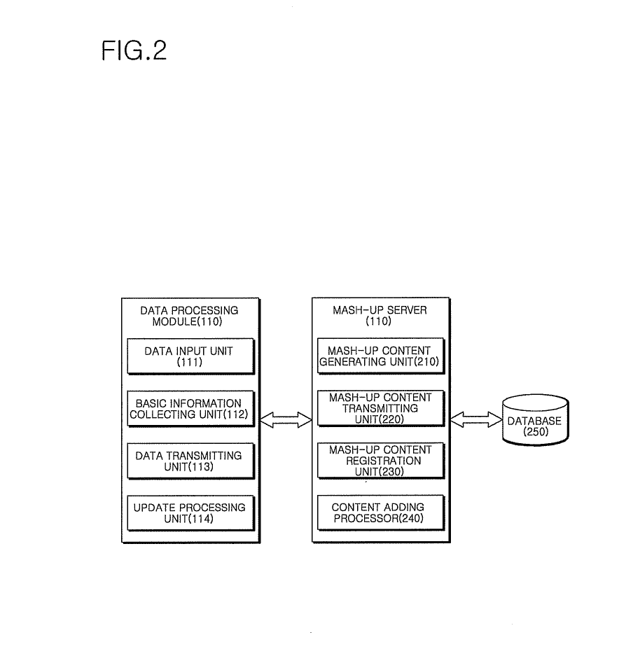

FIG. 2 is a block diagram of the data processing module 110 and the mash-up server 200 according to an embodiment of the present invention.

The construction of the data processing module 110 will be described with reference to FIG. 2. As illustrated in FIG. 2, the data processing module 110 includes a data input unit 111, a basic information collecting unit 112, a data transmitter 113, and a update processor 114. The data processing module 110 can be integrated with the communication terminal 100 (see FIG. 1) when manufacturing the communication terminal 100, or can be downloaded from the mash-up server 200 and installed in the communication terminal 100.

The data input unit 111 receives multimedia data which is created by a user. The multimedia data includes at least one among text, an image, animation, and audio. Here, the text is input to the data input unit 111 through a user interface, such as a key pad, a touch pad, a keyboard, of the communication terminal 100 in which the data processing module 110 is installed. Also, the images or animation can be photographed by a camera module of the communication terminal 100 and then signal-processed by an image signal processor, or can be stored in a removable flash memory card such as a multimedia card. The audio can be input from a microphone of the communication terminal 100 in which the data processing module 110 is installed, or can be stored in advance in a memory of the communication terminal 100.

The basic information collecting unit 112 collects basic information which can be provided by the communication terminal 100 when a request command for transmitting the multimedia data to the mash-up server 200 is received. Here, the basic information which is provided by the communication terminal 100 includes terminal identification information, a current time, and terminal location information. The data transmitter 113 transmits the basic information and multimedia data to the mash-up server 200. The update processor 114 downloads a new data processing module from the mash-up server 200 and updates the data processing module 110 to the new data processing module.

The construction of the mash-up server 200 will be described with reference to FIG. 2. Referring to FIG. 2, the mash-up server 200 includes a mash-up content generator 210 and a mash-up content transmitter 220.

If the mash-up content generator 210 receives the multimedia data and basic information from the data processing module 110, the mash-up content generator 210 tags the multimedia data with the basic information, and creates mash-up content. Generally, the term tagging means processing a keyword (or a tag value) which can represent an image or text. For example, if terminal location information included in the basic information is a location value corresponding to “Yuseong-gu, Daejeon City”, the mash-up content generator 210 can give a tag value of “Yuseong-gu, Daejeon City” to the multimedia data. The mash-up content transmitter 220 transmits the mash-up content to the mash-up service apparatus 300 (see FIG. 1). Accordingly, a user of the mash-up service apparatus 300 can view the corresponding mash-up content by using a search word “Yuseong-gu, Daejeon City”.

According to an embodiment of the present invention, the mash-up content generator 210 can generate the mash-up content according to the RSS data format, and the mash-up content transmitter 220 can be based on the RSS transfer protocol. Here, the RSS is short for Really Simple Syndication or Rich Site Summary, and is a XML-based standard communication format. RSS version 0.9 has been initially developed by Netscape, and recently, RSS 1.0 developed by RSS-DEV Working Group and RSS 2.0 developed by UserLand are competing to be adopted as a standard for RSS.

The mash-up server 200 can further include a mash-up content registration unit 230 for creating a content list for the mesh-up content and storing the content list and the mash-up content in a database 250. In the current embodiment, the mash-up content transmitter 220 transmits the content list to the mash-up service apparatus 300, and reads mash-up content corresponding to the content list from the database 250 and transmits the mash-up content to the mash-up service apparatus 300 if a content request message including the content list is received from the mash-up service apparatus 300.

The mash-up server 200 can further include a content adding processor 240 for transmitting a content request message including basic information to a content providing server if the mash-up server 200 receives multimedia data and the basic information from the data processing module 110, and receiving content corresponding to the basic information from the content providing server. For example, if the multimedia data is a text saying “Please, find good restaurants near the City Cinema˜!!” and terminal location information included in the basic information is a location value corresponding to Yeaksam-dong, the content adding processor 240 can receive data regarding local weather near Yeaksam-dong, coupon images that are available in good restaurants near Yeaksam-dong, and performances, occasions, and affairs/accidents near Yeaksam-dong, from, for example, a weather providing server, a coupon providing server, and an event providing server, respectively.

In the current embodiment, the mesh-up content generator 210 processes the multimedia data and the content received from the content adding processor 240, thus creates new mash-up data, and tags the new mash-up data with the basic information, thereby generating mash-up content.

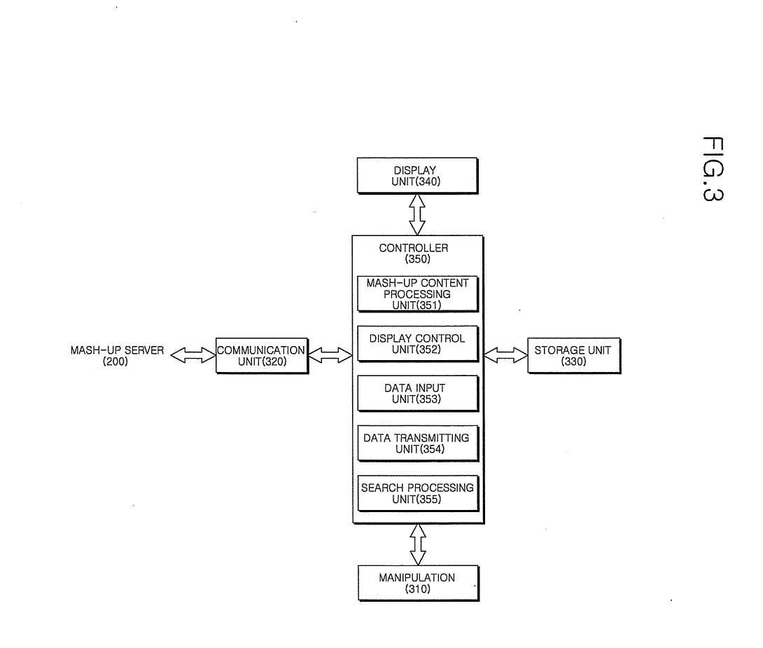

FIG. 3 is a block diagram of a mash-up service apparatus according to an embodiment of the present invention. Referring to FIG. 3, the mash-up service apparatus includes a manipulation unit 310, a communication unit 320, a storage unit 330, a display unit 340, and a controller 350.

The manipulation unit 310 is implemented as means which can receive a manipulation command and data from a user, and may be a key pad, a touch panel, a voice recognition unit, etc., each of which consists of number keys, function keys, etc. The communication unit 320 accesses the Internet network and receives/transmits data via the Internet network. The communication unit 320 may be a LAN card or a wireless modem. The storage unit 330 may be a static random access memory (SRAM) having a capacity of several mega bits, a large capacity flash memory, a hard disk driver, or a removable flash memory card such as a multimedia card. The display unit 340 displays the operation processing state of the mash-up service apparatus 300 (see FIG. 1), a user menu selection screen, etc., and may be a well-known display such as a liquid crystal display (LCD).

The controller 350 controls the entire operation of the system, and preferably may be a microprocessor into which a ROM, a RAM, and peripheral devices are integrated. The controller 350 includes a mash-up content processor 351, a display controller 352, a data input unit 353, a data transmitter 354, and a search processor 355. The mash-up content processor 351 accesses the mash-up server 200 through the communication unit 320, downloads mash-up content from the mash-up server 200, and stores the mash-up content in the storage unit 330. Preferably, the mash-up content processor 351 downloads the mash-up content in real time.

The display controller 352 reads the mash-up content from the storage unit 330 according to a manipulation command which is received from the manipulation unit 310, and displays the mash-up content on a screen. According to an embodiment of the present invention, the display controller 352 marks a generation location of the mash-up content on a map, using terminal location information included in basic information of the mash-up content. If a selection command for selecting the generation location of the mash-up content is received from the manipulation unit 310, the display controller 352 reads the mash-up content corresponding to the generation location of the mash-up content from the storage unit 330, and displays the mash-up content on the screen.

The data input unit 353 receives a user response message for the mash-up content from the manipulation unit 310 or the storage unit 330. The user response message may be at least one among text, an image, animation, and audio. Here, the text is received through a user interface, such as a keypad, a touch panel, a keyboard, etc. Also, the image or animation can be photographed by a camera or camcorder and then stored in the storage unit 330, or can be stored in a removable flash memory card such as a multimedia card. The audio can be received from a microphone, or can be stored in advance in the storage unit 330.

If a request command for transmitting the user response message to the mash-up server 200 is received from the manipulation unit 310, the data transmitter 354 transmits the user response message to the mash-up server 200 through the communication unit 320. If a search command including a search word is received from the manipulation unit 310, the search processor 355 searches for mash-up content corresponding to the search word from the storage unit 330, and outputs the result of the search.

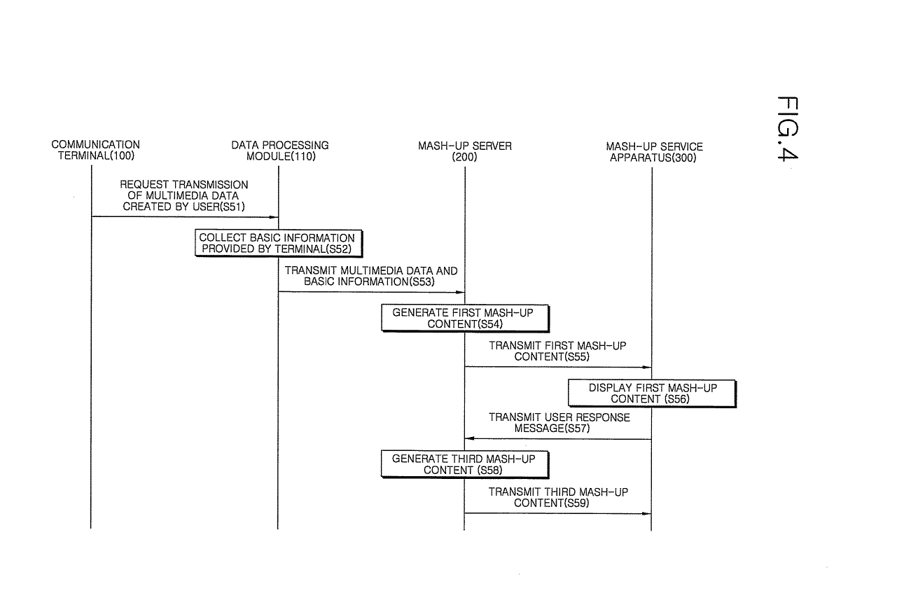

FIG. 4 is a flowchart of a mash-up service according to an embodiment of the present invention.

In the current embodiment, the mash-up service can be executed by a mash-up service system including a communication terminal 100, a data processing module 110 which is installed in the communication terminal 100, a mash-up server 200, and a mash-up service apparatus 300.

First, the communication terminal 100 creates multimedia data including at least one among text, an image, animation, and audio, according to a user's manipulation. The communication terminal 100 receives a request command for transmitting the multimedia data to the mash-up server 200, from a user, and outputs the request command to the data processing module 110 (operation S51).

If the data processing module 110 receives the request command, the data processing module 110 collects basic information which can be provided by the communication terminal 100 (operation S52). Here, the basic information includes terminal identification information, a current time, and terminal location information. For example, the data processing module 110 collects the basic information through data exchange with a main program of the communication terminal 100. Thereafter, the data processing module 110 transmits the multimedia data and basic information to the mash-up server 200 (operation S53).

If the mash-up server 200 receives the multimedia data and basic information, the mash-up server 200 tags the multimedia data with the basic information, and creates first mash-up content (operation S54). If the multimedia data includes an image of the City Cinema and text of “Please, find good restaurants near the City Cinema˜!!”, and terminal location information included in the basic information is a location value corresponding to Yeaksam-dong, the mash-up server 200 can assign a tag value of “Yeaksam-dong” to the multimedia data. Thereafter, the mash-up server 200 transmits the first mash-up content to the mash-up service apparatus 300 (operation S55).

The mash-up service apparatus 300 displays the first mash-up content on a screen (operation S56). The mash-up service apparatus 300 receives a user response message including at least one among text, an image, animation, and audio, which are related to the first mash-up content. Here, the text can be received through a user interface, such as a keypad, a touch panel, a keyboard, etc. Also, the image or animation can be photographed by a camera or camcorder and stored in the storage unit, or can be stored in a removable flash memory card such as a multimedia card. The audio can be input from a microphone, or can be stored in advance in the storage unit. Thereafter, the mash-up service apparatus 300 transmits the user response message and the first mash-up content to the mash-up server 200 (operation S57).

If the mash-up server 200 receives the user response message from the mash-up service apparatus 300, the mash-up server 200 adds the user response message to the first mash-up content, thus creates third mash-up content (operation S58), and transmits the third mash-up content to the mash-up service apparatus 300 (operation S59).

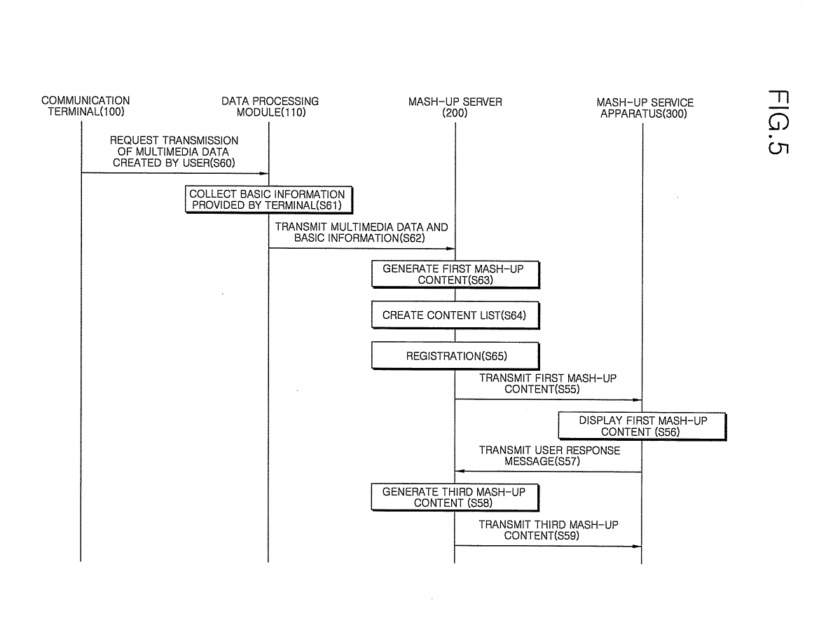

FIG. 5 is a flowchart of a mash-up service according to another embodiment of the present invention.

In the current embodiment, the mash-up service can be performed by a mash-up service system including a communication terminal 100, a data processing module 110 installed in the communication terminal 100, a mash-up server 200, and a mash-up service apparatus 300.

First, the communication terminal 100 creates multimedia data including at least one among text, an image, animation, and audio, according to a user's manipulation. The communication terminal 100 receives a request command for transmitting the multimedia data to the mash-up server 200, from a user, and outputs the request command to the data processing module 110 (operation S60).

If the data processing module 110 receives the request command, the data processing module 110 collects basic information which can be provided by the communication terminal 100 (operation 61). The basic information includes at least one among terminal identification information, a current time, and terminal location information. For example, the data processing module 110 collects the basic information through data exchange with a main program of the communication terminal 100. Thereafter, the data processing module 110 transmits the multimedia data and basic information to the mash-up server 200 (operation S62).

If the mash-up server 200 receives the multimedia data and basic information from the data processing module 110, the mash-up server 200 tags the multimedia data with the basic information, and creates first mash-up content (operation S63). For example, if the multimedia data includes an image of the City Cinema and text of “Please, find good restaurants near the City Cinema˜!!”, and terminal location information included in the basic information is a location value corresponding to Yeaksam-dong, the mash-up server 200 can assign a tag value of “Yeaksam-dong” to the multimedia data. Thereafter, the mash-up server 200 creates a content list for the first mash-up content, and registers the content list and the first mash-up content in the database (operation S65). Then, the mash-up server 200 transmits the content list to the mash-up service apparatus 300. If the mash-up server 200 receives a content request message including the content list from the mash-up service apparatus 300, the mash-up server 200 reads the first mash-up content corresponding to the content list from the database, and transmits the first mash-up content to the mash-up service apparatus 300 (operation S66).

The mash-up service apparatus 300 receives the first mash-up content from the mash-up server 200, and displays the first mash-up content on a screen (operation S67). The mash-up service apparatus 300 receives a user response message including at least one among text, an image, animation, and audio, which are related to the first mash-up content. Here, the text is received through a user interface, such as a keypad, a touch panel, a keyboard, etc. The image or animation can be photographed by a camera or camcorder and stored in a storage unit, or can be stored in a removable flash memory card such as a multimedia card. The audio can be input from a microphone, or can be stored in advance in the storage unit. Thereafter, the mash-up service apparatus 300 transmits the user response message and the first mash-up content to the mash-up server 200 (operation S68).

If the mash-up server 200 receives the user response message from the mash-up service apparatus 300, the mash-up server 200 adds the user response message to the first mash-up content, thus creates third mash-up content (operation S69), and transmits the third mash-up content to the mash-up service apparatus 300 (operation S70).

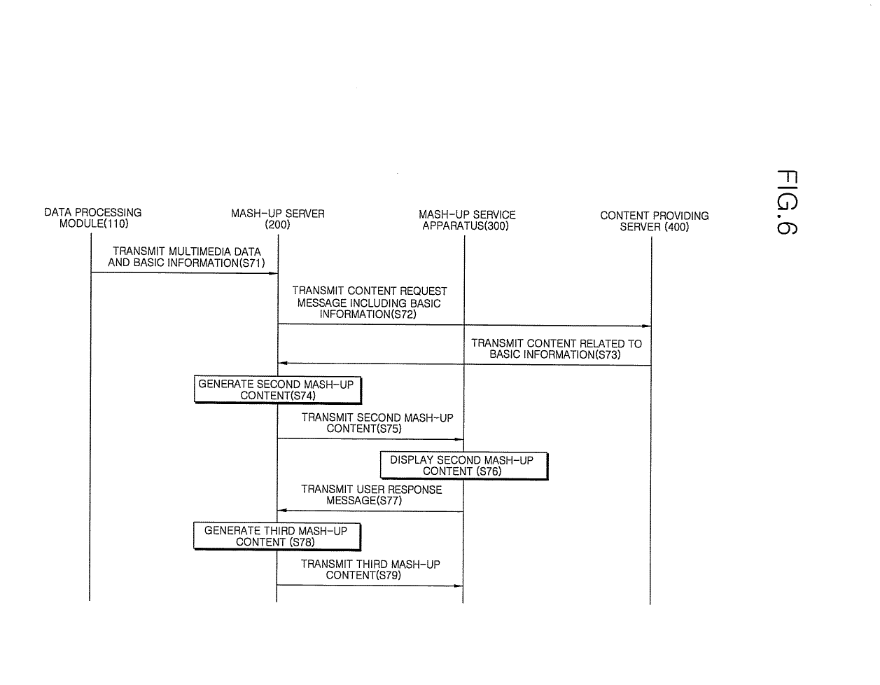

FIG. 6 is a flowchart of a mash-up service according to a still another embodiment of the present invention.

In the current embodiment, the mash-up service can be executed by a mash-up service system including a data processing module 110 installed in a communication terminal, a mash-up server 200, a mash-up service apparatus 300, and a content providing server 400. Here, the content providing server 400, which is a web server established by existing content providers, includes at least one among a map providing server, a weather providing server, a coupon providing server, an event providing server, and an advertisement providing server. Here, the event includes an art exhibition, a performance, an occasion, and an affair/accident.

First, as not illustrated in the drawings, if a data transmission command and multimedia data including at least one among text, an image, animation, and audio are received from the communication terminal, according to a user's manipulation, the data processing module 110 collects basic information which can be provided by the communication terminal. Here, the basic information includes at least one among terminal identification information, a current time, and terminal location information. For example, the data processing module 110 collects the basic information through data exchange with a main program of the communication terminal. The data processing module 110 transmits the multimedia data and basic information to the mash-up server 200 (operation S71).

If the mash-up server 200 receives the multimedia data and basic information from the data processing module 110, the mash-up server 200 transmits a content request message including the basic information to the content providing server 400 which is connected to the mash-up server 200 through a network (operation S72), and receives content corresponding to the basic information from the content providing server 400 (operation S73). For example, if the multimedia data is text of “Please, find good restaurants near the City Cinema˜!!”, and terminal location information included in the basic information is a location value corresponding to Yeaksam-dong, the mash-up server 200 transmits a content request message including the basic information to, for example, the weather providing server, the coupon providing server, and the event providing server, and can receive data regarding local weather near Yeaksam-dong, coupon images that are available in good restaurants near Yeaksam-dong, and performances, occasions, and affairs/accidents near Yeaksam-dong, from the weather providing server, the coupon providing server, and the event providing server, respectively.

Thereafter, the mash-up server 200 generates mash-up data on the basis of the multimedia data and the content transmitted from the content providing server 400, and tags the mash-up data with the basic information, thereby generating second mash-up content (operation S74). Then, the mash-up server 200 transmits the second mash-up content to the mash-up service apparatus 300 (operation S75).

The mash-up service apparatus 300 displays the second mash-up content on a screen (operation S76). The mash-up service apparatus 300 receives a user response message including at least one among text, an image, animation, and audio related to the second mash-up content. Here, the text is received through a user interface, such as a keypad, a touch panel, a keyboard, etc. Also, the image or animation can be photographed by a camera or camcorder and stored in a storage unit, or can be stored in a removable flash memory card such as a multimedia card. The audio can be received through a microphone, or can be stored in advance in the storage unit. Then, the mash-up service apparatus 300 transmits the user response message and the second mash-up content to the mash-up server 200 (operation S77).

If the mash-up server 200 receives the user response message and the second mash-up content from the mash-up service apparatus 300, the mash-up server 200 adds the user response message to the second mash-up content to create third mash-up content (operation S78), and transmits the third mash-up content to the mash-up service apparatus 300 (operation S79).

As described above, according to the present invention, a communication terminal's user can create and distribute new mash-up content through the Internet network by a simple manipulation of creating multimedia data and inputting a transmission command, and a mash-up content's user can use mash-up content in real time.

Also, a mash-up service system according to the present invention can create and distribute new mash-up content with abundant data by adding a variety of contents, such as a map, weather, advertisement, event information, coupon information, etc., to multimedia data created by a communication terminal's user.

Also, a mash-up service system according to the present invention can provide an interactive communication service between a communication terminal's user which creates and loads multimedia data on a mash-up server, and a user which uses content through the mash-up server.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A mash-up service system comprising:
a data processing module installed in a communication terminal which makes wired/wireless Internet communications, and transmitting multimedia data created by a user of the communication terminal and basic information provided by the communication terminal; and
a mash-up server receiving the multimedia data and the basic information from the data processing module, tagging the multimedia data with the basic information to create first mash-up content, and transmitting the first mash-up content to a mash-up service apparatus.

2. The mash-up service system of claim 1, wherein the data processing module comprises:
a data input unit receiving the multimedia data;
a basic information collecting unit collecting basic information provided by the communication terminal if a request command for transmitting the multimedia data to the mash-up server is received; and
a data transmitting unit transmitting the basic information and the multimedia data to the mash-up server.

3. The mash-up service system of claim 2, wherein the data processing module further comprises a update processing unit downloading a new data processing module from the mash-up server and updating the data processing module to the new data processing module.

4. The mash-up service system of claim 1, wherein the mash-up server comprises:
a mash-up content generating unit receiving the multimedia data and the basic information from the data processing module, and tagging the multimedia data with the basic information to create the first mash-up content; and
a mash-up content transmitting unit transmitting the first mash-up content to the mash-up service apparatus.

5. The mash-up service system of claim 4, wherein the mash-up server further comprises a mash-up content registration unit for creating a content list for the first mash-up content, and storing the content list and the first mash-up content in a database, and
the mash-up content transmitting unit transmits the content list to the mash-up service apparatus, and reads the first mash-up content corresponding to the content list from the database and transmits the first mash-up content to the mash-up service apparatus if a content request message including the content list is received from the mash-up service apparatus.

6. The mash-up service system of claim 1, wherein the basic information comprises terminal identification information, a current time, and terminal location information.

7. The mash-up service system of claim 1, wherein the multimedia data comprises at least one among text, an image, animation, and audio.

8. The mash-up service system of claim 4, wherein the mash-up content generating unit generates the first mash-up content according to a Really Simple Syndication (RSS) data format, and the mash-up content transmitting unit complies with an RSS transfer protocol.

9. The mash-up service system of claim 4, wherein the mash-up server further comprises a content adding processor receiving the multimedia data and the basic information from the data processing module, transmitting a content request message including the basic information to a content providing server connected to the mash-up server through a network, and receiving content related to the basic information from the content providing server, and
the mash-up content generates unit generating mash-up data from the multimedia data and the content received from the content adding processor, and tags the mash-up data with the basic information to generate second mash-up content.

10. The mash-up service system of claim 9, wherein the content providing server comprises at least one among a map providing server, a weather providing server, a coupon providing server, an event providing server, and an advertisement providing server.

11. The mash-up service system of claim 1, wherein the mash-up service apparatus receives the first mash-up content from the mash-up server, displays the first mash-up content on a screen, and transmits a user response message for the first mash-up content displayed on the screen to the mash-up server, and
the mash-up server receives the user response message from the mash-up service apparatus, adds the user response message to the first mash-up content to create third mash-up content, and transmits the third mash-up content to the mash-up service apparatus.

12. The mash-up service system of claim 11, wherein the mash-up service apparatus comprises:
a manipulation unit receiving a manipulation command and data from the user;
a communication unit receiving or transmitting data through an internet network;
a storage unit storing mash-up content received through the communication unit;
a mash-up content processing unit accessing the mash-up server through the communication unit, downloading the mash-up content from the mash-up server, and storing the mash-up content in the storage unit;
a display control unit reading the mash-up content from the storage unit according to a manipulation command received from the manipulation unit, and displaying the mash-up content on the screen;
a data input unit receiving a user response message for the mash-up content from the manipulation unit or the storage unit; and
a data transmission unit receiving a request command for transmitting the user response message to the mash-up server from the manipulation unit, and transmitting the user response message to the mash-up server through the communication unit.

13. The mash-up service system of claim 12, wherein the mash-up service apparatus further comprises a search processing unit receiving a search command including a search word from the manipulation unit, searching for mash-up content corresponding to the search word from the storage unit, and outputting the mash-up content.

14. The mash-up service system of claim 12, wherein the display control unit displays a generation location of the mash-up content on a map, using terminal location information included in basic information of the mash-up content, and
if a selection command for selecting the generation location of the mash-up content displayed on the map is received from the manipulation unit, the display control unit reads the mash-up content corresponding to the generation location of the mash-up content from the storage unit, and displays the mash-up content on the screen.

15. The mash-up service system of claim 11, wherein the user response message includes at least one among text, an image, animation, and audio.
